(19) United States
(12) Patent Application Publication
(10) Pub. No.: US 2008/0038588 A1
(43) Pub. Date: Feb. 14, 2008

(54) Battery With Porous Material and Fabrication Method Thereof

(76) Inventor: Ki Bang Lee, Seoul (KR)

Correspondence Address: DARBY & DARBY P.C., P.O. BOX 770, Church Street Station, New York, NY, 10008-0770, US

(21) Appl. No.: 11/574,708

(22) PCT Filed: Sep. 6, 2005
(86) PCT No.: PCT/KR05/02953

§ 371 Date: Mar. 5, 2007

(30) Foreign Application Priority Data
Sep. 9, 2004 (KR) 10-2004-0071978

(51) Int. Cl. H01M 14/00; H01M 2/00; H01M 2/12

(52) U.S. Cl. 429/2; 156/60; 29/623.1; 429/110; 429/72; 429/82

(57) ABSTRACT

The present invention relates to batteries that can be activated by liquid. The battery with porous material is suitable for disposable healthcare test kits, bioMEMS (bio Micro Electro Mechanical Systems) and biosystems such as DNA chips, lab-on-a-chip or micro fluidics and can be easily integrated with disposable devices/systems.

### FIELD OF THE INVENTION

The present invention relates to batteries that can be activated by liquid. The battery with porous material is suitable for disposable healthcare test kits, bioMEMS (bio Micro Electro Mechanical Systems) and biosystems such as DNA chips, lab-on-a-chip or micro fluidics and can be easily integrated with disposable devices/systems.

### BACKGROUND OF THE INVENTION

The advances in the areas of MEMS (Micro Electro Mechanical Systems) and micromachining over the past decades have made possible the fabrication of micro- and nano-level systems such as the lab-on-a-chip, DNA chip, microfluidic devices, optical Microsystems and micro-transceiver. Using batch process such as bulk and surface micromachining technology, these MEMS or bioMEMS devices can be easily fabricated with microactuator, microsensor and circuits on a substrate. Today, the applications of these nano-scale devices have diversified into a myriad of purposes, most notably in the area of the sensing and amplification of bio-signals. Indeed, the application of nanotechnology to the development of biosensors constitutes one of the main thrusts in today biotechnology research.

However, one of the major problems face by current MEMS or bioMEMS, DNA chips, lab-on-a-chip, healthcare test kit, and biosystem technologies is that of the energy source. Although systems such as lab-on-a-chip or DNA chip are fabricated on a chip, the current Microsystems still require electrical energy from external conventional battery or light for detection. For example, a microarray (DNA chip) requires an ultraviolet scanner to detect DNA hybridization information on a chip.

### BRIEF DESCRIPTION OF THE DRAWINGS

FIG. 1 is a perspective view of a battery embodying the principles of this invention.

FIG. 2 is a fabrication process for the present battery.

FIG. 3 is a preparation method for the CuCl-doped paper.

FIG. 4 is a optical photograph of the prototype battery.

FIG. 5 is a scanning electron microscope picture of the cross-section of the prototype battery of FIG. 4.

FIG. 6 is a measured voltage of the prototype battery shown in FIG. 4

### SUMMARY OF THE INVENTION

It is an objective of the present invention to provide liquid-activated battery to supply electricity that is required by disposable healthcare test kits, bioMEMS (bio Micro Electro Mechanical Systems) and biosystems such as DNA chips, lab-on-a-chip or microfluidic devices. It is another object of this invention to provide easy fabrication of the battery that may be easily integrated with disposable devices/systems.

To achieve the above object, the following batterys and fabrication methods might be made.

There is disclosed herein a battery including in combination:
an anode that supplies electrons;
a porous material that includes a cathode material to accepts said electrons;
a current collector that collects said electrons;
a housing (predetermined-gap-maintaining means) that maintains predetermined gap or distance between said anode, porous material and current collector;
wherein the surface tension or capillary force drives introduced liquid into said porous material, and then said anode and said cathode in said porous material is activated to supply electricity when said liquid is introduced to said porous material.

In addition to the embodiment of this invention, the following in any combination may provide better battery.
liquid is a liquid based on water.
said water-based liquid include at least one of the following; 1) blood, sweat, saliva, snivel, urine, vaginal discharge, feces, biofluid, DNA, RNA, protein, cell or cell debris of an animal; 2) sap, DNA, RNA, protein, cell or cell debris of a plant.
said porous material attaches at least one of said anode or current collector.
said anode is magnesium.
said cathode in said porous material is chloride such as copper chloride (CuCl) or silver chloride (AgCl).
said porous material is paper based on pulps such as wood pulp and rayon pulp.
said porous material is nitrocellulose.
said housing is made of at least one of the following: rubber, plastic, wood, paper and metal.
said housing is a housing that is made by using at least one of the following: plastic lamination; heat embossing; hot embossing; ultraviolet embossing; ultraviolet curing of a liquid substance; photolithographic techniques including patterning a thin film, deposit or etching; ultrasonic forming; pressure forming; thermal forming; vacuum forming; blow molding; stretch molding; insert molding; injection molding; extrusion casting; compression molding; die casting; and encapsulation processes.
said housing is fabricated by using combination of components or parts fabricated by plastic molding
adhesive is used to bond plastic to metal or plastic to plastic.
bonding plastic to metal or plastic to plastic use at least of the following: phase changes from solid to liquid or solid to gas.
one of diffusion phenomenon of a material is used to bond a plastic to plastic or plastic to metal.
one of heating or pressing is to bond a plastic to another.
at least one of the following energy is used to laminate or bond the plastic or housing materials: acoustic waves including ultrasonic waves and an audible sound; electromagnetic waves including radio frequency wave, infrared rays, ultraviolet, visible rays and laser; pressure welding; fusion welding; soldering; and friction welding.
the sandwich consisting said anode, porous material and current collector has at least one channel (inlet or outlet) between said porous and outside to be used for introduction of said liquid or for removal of gas in said sandwich.
said anode and cathode is connected to external circuit via a conductor.
a conducting adhesive is used to make an electrical contact between said conductor and said external circuit.
said electrical connection utilizes mechanical connectors that has extrusion and hollow portions (or hook and eyes).

There is further disclosed herein a planar battery including in combination:
an anode that supplies electrons;
a porous material that includes a cathode material to accepts said electrons;
a current collector that collects said electrons;
a planar plastic housing (predetermined-gap-maintaining means) that maintains predetermined gap or distance between said anode, porous material and current collector;
wherein the surface tension or capillary force drives introduced liquid into said porous material, and then said anode and cathode in said porous material is activated to supply electricity when said liquid is introduced to said porous material.

There is further disclosed herein a planar battery including in combination:
an anode that supplies electrons;
a porous material;
a current collector that collects said electrons;
a planar plastic housing (predetermined-gap-maintaining means) that maintains predetermined gap or distance between said anode, porous material and current collector;
wherein the surface tension or capillary force drives introduced liquid with cathode material into said porous material, and then said anode and cathode in liquid is activated to supply electricity when said liquid is introduced to said porous material.

There is further disclosed herein a battery fabrication method in including in combination:
a process for making sandwich including following in any combination;
   a) placing a current collector;
   b) placing a porous material that includes a cathode material;
   c) placing an anode;
a process to provide a housing (predetermined-gap-maintaining means) that maintains predetermined gaps or distances between said anode, porous material and current collector of said sandwich;

In addition to the embodiment of this invention, the following in any combination may provide better battery fabrication methods.
lower or upper portion of said housing includes at least one of the following: rubber, plastic, and metal.
an adhesive is used for bonding a plastic to another plastic.
bonding plastic to metal or plastic to plastic use at least of the following: phase changes from solid to liquid or solid to gas.
one of diffusion phenomenon of a material is used to bond a plastic to another.
one of heating or pressing is used to bond a plastic to another.
at least one of the following energy is used to laminate or bond the plastic or housing materials: acoustic waves including ultrasonic waves and an audible sound; electromagnetic waves including radio frequency wave, infrared rays, ultraviolet, visible rays and laser; pressure welding; fusion welding; soldering; and friction welding.

There is further disclosed herein a battery including in combination:
an anode that supplies electrons;
a current collector that collects said electrons;
a medium that exists between said anode and current collector;
a housing (predetermined-gap-maintaining means) that maintains predetermined gap or distance between said anode, porous material and current collector;
wherein the surface tension or capillary force drives introduced liquid into said medium, and then said anode and cathode contacting with said medium is activated to supply electricity when said liquid is introduced to said medium.

In addition to the embodiment of this invention, the following in any combination may provide better battery.
said liquid is a liquid based on water.
said water-based liquid include at least one of the following; 1) blood, sweat, saliva, snivel, urine, vaginal discharge, feces, biofluid, DNA, RNA, protein, cell or cell debris of an animal; 2) sap, DNA, RNA, protein, cell or cell debris of a plant.
said medium consists of at least one of the following: empty cavity and porous material consisting of hydrophilic material and cavity.
said medium consists of porous materials or stuff with microchannels.
said is at least a cavity between said anode and current collector.
some or all portion of said medium, porous material or cavity includes said cathode that can accept said electrons.
said cathode is chloride such as copper chloride (CuCl) or silver chloride (AgCl).
said anode is magnesium.
the sandwich consisting said anode, medium and current collector has at least one channel (inlet or outlet) between said medium and outside to be used for introduction of said liquid or for removal of gas in said sandwich.
the structure of the battery is in planar shape that could be fabricated by using lamination.
said introduced or circulated liquid includes cathode material that can accept electrons.
said battery works while said liquid moves from one position to others.

### DESCRIPTION OF THE PREFERRED EMBODIMENTS

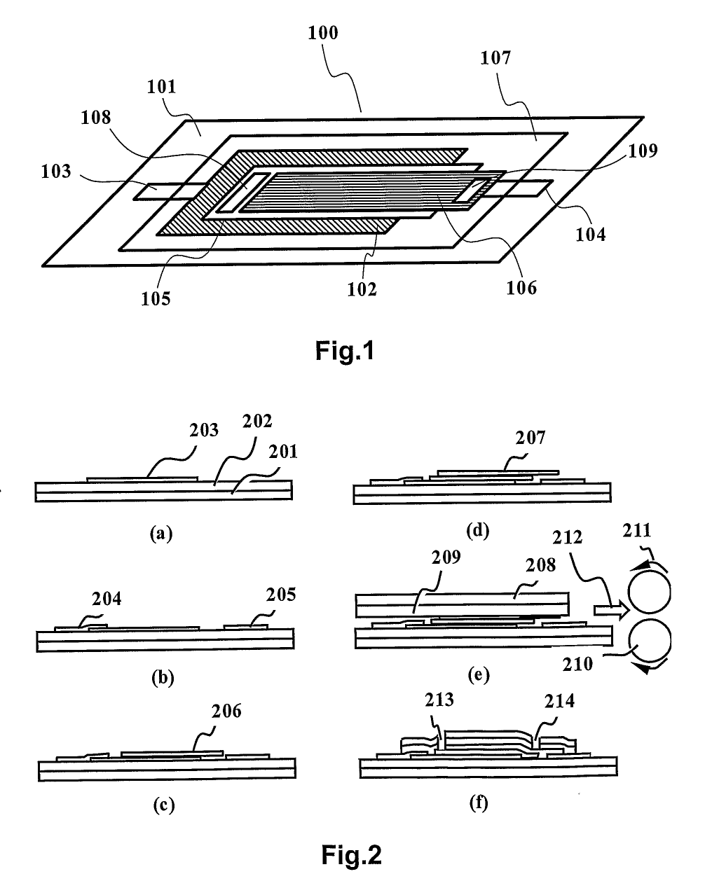

FIG. 1 show one of the preferred embodiments of the present battery, activated by liquid(water)-activated battery. The battery 100 consists of a sandwich including copper layer 102 for collecting electrons, copper chloride(CuCl)-doped paper 105 and magnesium layer 106 as a anode between lower and upper transparent plastic film 101 and 107. The numbers 103 and 104 are the electrodes for electrical connections of the copper layer 102 and the magnesium layer 106, respectively. The numbers 108 and 109 are the introduction hole (slit) for liquid such as water and biofluid and the air exhalation hole (slit) to be used for air removal from the paper. The copper layer 102 is used for a current collector that collects electron via a load (not shown in FIG. 1) and can be replaced with any other conductive materials. The paper 105 for CuCl is substituted with any other porous materials that have holes or channel for liquid flow. For example, we can use the following in any combination: papers, plastic, organic material such as dried wood, inorganic material such as sand or dust, porous metal and scratched materials. The copper chloride (CuCl) in the paper 105 is a cathode that can accept electron via a load (not shown). Any other cathodes can be used for accepting the electrons. For example, silver chloride (AgCl) can be used as the cathode. Similarly, the anode 106 may be replaced with any other anodes such as zinc (Zn) that can generates electrons when they are involved in a chemical reaction.

With this embodiment of the present invention, we explain the working principle of the battery 100. For the easy explanation, we assume that there is a load (not shown) between the electrodes 103 and 104. As a liquid to activate the battery 100, urine is used in this explanation. But any other liquid including water may be used as the activating liquid. When human urine (not shown) is placed on the slit 108 for urine introduction, the surface tension or capillary force drives the urine into small cavity or microchannel (not shown) inside the paper 105 and the urine contact copper chloride (CuCl) in the paper and magnesium on the paper. The magnesium first oxides to provide electrons to the load (not shown), and the CuCl in the paper is reduced to accept the electrons via the load and the copper layer serves as a current collector. The following is the overall electrochemical reaction for the battery.
Mg+2CuCl−>MgCl₂+2Cu (Equation 1)
According to the above reaction activated by urine, electrons flow out via the load (not shown) to supply electricity to the load. The battery works when the urine is introduced and moves into the paper or even when the urine fills out the small cavities in the battery. Furthermore the battery works when the urine or other water-based solution continuously flows or circulates through the cavities, holes or microchannels in the paper. For this purpose, any devices or pumps (not shown) may be used for pressure generation in the battery.

In many case, planar and thin shape of the above battery is preferred for healthcare test kits/biochip but not limited to the battery shapes. FIG. 2 illustrates one of the preferred fabrication methods that use plastic film lamination. The plastic lamination is used to provide a housing or a sandwich-maintaining means that maintains or keeps the predetermined gaps among the copper layer, the CuCl-doped paper, and the magnesium. The magnesium is on the CuCl-doped paper or is spaced apart from the paper by predetermined distance in order to reduce flow resistance. Similarly, the CuCl-doped paper is attached on the copper layer or is between the copper layer and the magnesium layer. For easy explanation, the sandwich without gap or distance between the layers is used here. The plastic transparent film (eg. polyester 100 micrometers) 201 with adhesive 202 (thermoplastic, eg. polyethylene 50 micrometers) is used as a substrate in FIG. 2.

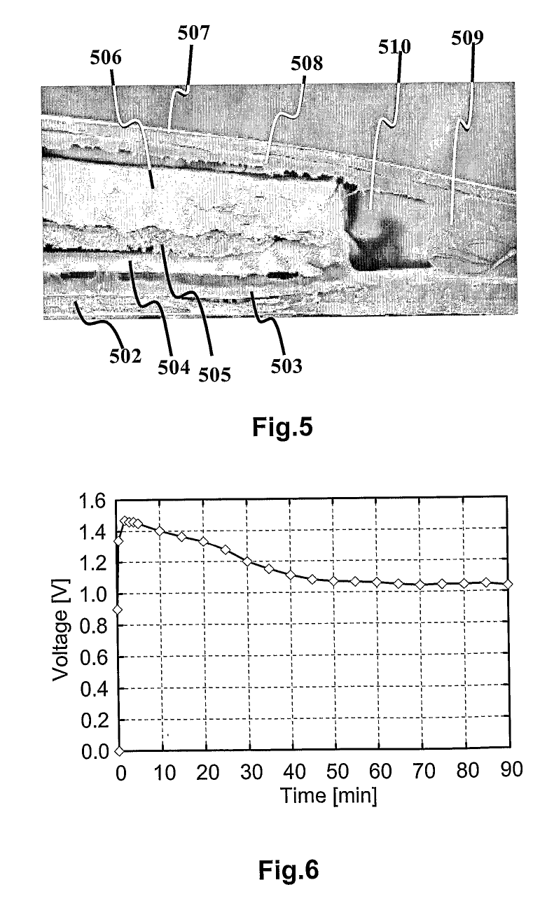

FIG. 2 is a cheap fabrication process developed for the battery 100 shown in FIG. 1. In the FIG. 2, a plastic lamination is used as a housing or a sandwich-maintaining means. The process starts with a 0.15 mm-thick lower transparent plastic film 201 coated with an adhesive 202 and this serves as a substrate for the battery. In the step of FIG. 2(a), a 0.2 mm-thick Copper (Cu) layer 203 is deposited (or taped) on the adhesive 202 and patterned as the positive electrode. A 0.2 mm-thick aluminum (Al) layer in FIG. 2(b) is then deposited and patterned to provide electrical connection and as electrodes 204 and 205. The said copper and aluminum may be made of by using any other layer-making technologies such as evaporation, sputtering, electroplating, screen-printing, brushing and molding. Taping and patterning technologies such etching are also employed for making the metal on the substrate. In FIGS. 2(c) and (d), a 0.2 mm-thick CuCl paper 206 and Magnesium (Mg) layer 207 are stacked onto the Copper layer thereafter covered on the top by a upper transparent plastic film 208 with an adhesive layer 209 in FIG. 2e. Finally the all the layers are laminated into a paper battery by passing in the direction of the arrow 212 through heating rollers 210 and 211 at 120° C. Urine supply slit 213 and air exhalation slit 214 are made on the upper plastic film in FIG. 5(f). It is noted from FIG. 5 (e) that the heating rollers press and bond all layers into the paper battery. Other bonding means such as ultrasonic heating equipment or press could be used instead of the heating rollers 210 and 211.

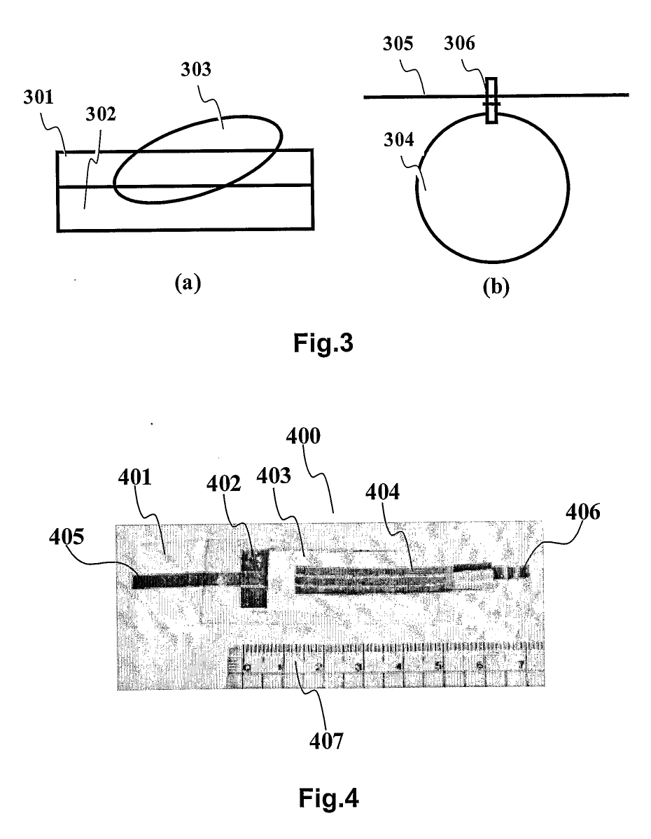

FIG. 3 shows a preparation method for the CuCl-doped paper 206 that was used in FIG. 2. Porous material such as a filter paper (Whatman, Cat No 1001070) is used for preparation of the CuCl-doped paper (or porous material) 206. The suspension solution 302 in a beaker 301 has 3 g CuCl in water of 100 ml. After soaking a sheet of the filter paper 303 in the Copper Chloride suspension 302 in FIG. 3(a), the paper 303 include CuCl that is distributed in the whole paper. The paper 304 hung on a wire 305 via clothespin 306 is dried in the air in FIG. 3(b) and cut into small pieces for the battery fabrication. In FIG. 3, the CuCl-doped paper is prepared by hand in a laboratory but is not limited to this method. Any preparation methods can be used for this preparation of the paper or porous material with CuCl or any cathode materials. We can use any mechanisms or machines such as conveyer belt and press if needed for the preparation. Furthermore, other preparation of the CuCl-doped paper may be possible. For example, we can directly deposit CuCl power or CuCl paste on a paper. Both sides or one side of the paper can have the CuCl layer for the cathode. If one side of the paper has the CuCl layer, the CuCl layer can face the copper layer 203 in FIG. 2 and pure paper side without CuCl layer will face the magnesium layer 207 in FIG. 2. This configuration make the battery more chemically stable. Similarly, CuCl-doped paper and pure paper (or other porous material) are bonded or attached to be used for the paper 206 in FIG. 2. So far, paper is shown for preparation of the CuCl paper (porous material with cathode material) that include soaking the paper in CuCl suspension solution and applying a CuCl paste on the paper. To provide the porous material 206 with CuCl, we can use one of the following: screen-printing of CuCl paste consisting of CuCl and Taping of CuCl paper. The paste for screen-printing may include CuCl power, binder for improving adhesion, conducting material such as carbon black or activated carbon for good conductance.

For cheap batteries, screen-printing technology is used for making the sandwich of the current collector, paper (with or without cathode), and anode on a substrate. For example, in the fabrication process of FIG. 2, all essential layers can be screen-printed as follows: 1) screen-printing a conductor such as silver paste or carbon paste, 2) screen-printing a paste with cathode, and 3) screen-printing an anode paste that may include anode material. Furthermore, we can fabricate a battery that does not have upper plastic film and lower plastic film in FIG. 2. In this case, a battery sandwich may consist of a copper layer as a substrate, a paper layer and a magnesium layer where the paper layer is bonded to others by a paste to make a electrical contact between layers.

FIG. 4 shows the photograph of the prototype paper battery 400 where all layers of copper, CuCl-doped filter paper and magnesium are bonded together between the transparent upper and lower plastic films as shown in FIG. 2. The overall dimension is 6 cm×3 cm and the CuCl-doped paper is 4 cm×2 cm. Three pieces of Magnesium (Mg) of 0.2 mm×3 mm×5 cm are used to provide greater reaction area. We can define copper layer 402, CuCl-doped paper 403, and magnesium 404 between the transparent plastic film 401 and find that the copper layer 402 and magnesium 404 are connected to aluminum electrodes 405 and 406 for electrical connection. The number 407 is a ruler for measuring dimension. FIG. 5 shows the SEM micrograph of the cross-section of the laminated paper battery shown in FIG. 4. The stack of the active layers of Magnesium (Mg) 506, CuCl-doped paper 505 and Copper (Cu) 504 could be seen between the upper and lower plastic layers 507 and 502. Adhesive 508 and 503 on the upper and lower plastic layers has melted and solidified to hold the active layers together when the whole layer is laminated into the paper battery in FIG. 2(e). 509 and 510 are a bonded adhesive and micro-cavity formed between the plastic layers.

FIG. 6 shows the measured voltage outputs of the fabricated battery in FIG. 5 with load resistor of 10 kΩ after a droplet of human urine of 0.2 ml is placed on the urine supply slit 108 of FIG. 1. The output voltage of the battery reaches the maximum voltage of 1.47V, decreases with time and remains at a constant voltage of 1.04V for 90 minutes.

The battery may be connected to external electrical circuit via conductors. For convenient connection, the anode (eg. Magnesium) or current collector (eg. Copper layer) may have conducting adhesive for electrical connection of the battery to a external circuit. Using this conduction adhesive, we can easily attach the battery to external systems such as a diagnostic kit for disease that needs electricity. For the same purpose of electrical connection, we can use mechanical connectors that has extrusion and hollow portions (or hook and eyes), similar to power outlet and connector at home.

So far, we described a battery that includes a porous material (eg. filter paper) with cathode material (eg. CuCl) and is activated by water or water-based liquid that is introduced from outside. We can also make a battery in which the cathode material is not included in the porous material but an introduced liquid includes a cathode material. For example, we can consider a battery of FIGS. 1 and 2 whose paper does not have CuCl. An introduced electrolyte such as urine is guided along the paper and activates the battery. In this case, the cathode is an electrolyte such as uric acid that can be move into the battery by capillary force. The battery activates when the introduced liquid start to move into the battery or when the liquid keeps stopping after introduction. The battery is also working when the liquid such as urine is circulated through the porous material or microchannels between the anode and the current collector. Pump or any device/equipment may be used for the circulation or drive of the liquid in the porous material or microchannel.

Preferred embodiments are explained to realize the concept of the present invention. For instance, the preferred embodiments use a filter paper as a porous material. If a person understands this battery and try to use nitrocellulose or sponge-like material instead of the paper, all concepts are the same as shown in this patent. Therefore the simple modification belongs to this patent. According to the concept of the current battery, any porous material or any microchannels (single or multi microchannels) between an anode and a current collector can be used to transport liquid for battery activation. Copper chloride (CuCl) is explained as a cathode material in the preferred embodiments but the cathode is not limited to the CuCl. Any material that can accept electrons may be used as the cathode. If silver chloride (AgCl) is used as a cathode, the chemical reaction in the battery is represented as following.
Mg+2AgCl−>MgCl₂+2Ag (Equation 2)
Similarly, we can use any anode material instead of magnesium. For example, zinc (Zn) may be used as the anode if needed.

For the battery fabrication, only planar battery is mentioned as a typical battery but anybody understanding the invention may make batteries with cubic or spherical shapes or spiral shape like sushi. The battery housing fabrication used heating rollers for lamination of a plastic film with thermoplastic adhesive but any methods may be used to provide a housing or predetermined-gap-maintaining means. We can use at least one of the following energy to laminate or bond the plastic or housing materials: acoustic waves including ultrasonic waves and an audible sound; electromagnetic waves including radio frequency wave, infrared rays, ultraviolet, visible rays and laser; pressure welding; fusion welding; soldering; and friction welding.

Upper and lower plastic film are described for easy explanation of the fabrication but we may use at least one of plastics, metals such as aluminum, organic material such as paper or wood. Rubbers such as Poly dimethyl siloxane rubber (PDMS) may be used for better bio-capability in a specific application.

For liquid introduction or gas exhalation, channels, holes or slits in any shape for connection of the paper to outside (air) are shown in the embodiments. Any methods for the communication or connection between the paper and outside (air) may be used for the same purpose. For example, if porous upper and lower plastic films are used for encapsulation or housing of the sandwich of porous magnesium, paper with CuCl, and porous copper, many microchannels or holes between the paper and outside (air) may be used for liquid introduction or gas exhalation.

The above-described embodiments are intended to be illustrative only and in no way limiting. The described embodiments are susceptible to many modifications of form, arrangement of part, details of order of operation. The invention, rather, is intended to encompass all such modification within its scope, as defined by the claims. Easy modification or simple combination of the embodiments or concepts of the invention belong to this invention.

### ADVANTAGE OF THE INVENTION

The battery may be activated by any biofluids (eg. urine, saliva, sweat or blood) or water from river or lake to operate healthcare test kit for disease detection, lab-on-a-chip, biosystems, bioMEMS (bio Micro Electro Mechanical Systems) or microfludic devices. When a droplet of the liquid contact the battery, battery is activated to supply electricity to the power consuming parts such as a healthcare test kit. Cheap and reliable batteries can be provided because the battery fabrication uses a simple plastic lamination that could be integrated with disposable plastic devices or systems.

1. A battery comprising:
(a) an anode for supplying electrons;
(b) a porous material comprising a cathode for accepting said electrons;
(c) a current collector for collecting said electrons;
(d) a housing for maintaining a predetermined gap between said anode, said porous material and said current collector; and
(e) wherein upon a liquid being introduced into said battery it is passed to said porous material for enabling activation of said anode and said cathode in said porous material for supplying electricity; said passing of said liquid being by one of: surface tension, and capillary action.

2. The battery of claim 1, wherein said liquid is a liquid based on water.

3. The battery of claim 2, wherein said liquid based or water liquid comprises at least one selected from the group consisting of: blood, sweat, saliva, snivel, urine, vaginal discharge, feces, biofluid, DNA of an animal, RNA of an animal, protein, cell of an animal, cell debris of an animal, sap, DNA of an plant, RNA of an plant, plant protein, cell of a plant, and cell debris of a plant.

4. The battery of claim 1, wherein said porous material is attached to at least one of: said anode, and said current collector.

5. The battery of claim 1, wherein said anode is of a magnesium material.

6. The battery of claim 1, wherein said cathode is of a chloride material.

7. The battery of claim 6, wherein the chloride is selected from the group consisting of: copper chloride, and silver chloride.

8. The battery of claim 1, wherein said porous material is a paper based on a pulp.

9. The battery of claim 1, wherein said porous material is nitrocellulose.

10. The battery of claim 1, wherein said anode, said porous material and said current collector comprise a sandwich, said sandwich having at least one channel for said introduction of said liquid and passing said liquid to said porous material.

11. The battery as claimed in claim 10, wherein said at least one channel is selected from the group consisting of: inlet, and outlet.

12. The battery as claimed in claim 10, wherein said at least one channel is also for the removal of gas in said sandwich.

13. The battery of claim 1, wherein said anode and said cathode are connectable to an external circuit by a conductor.

14. The battery of claim 13, further comprising a conducting adhesive for making an electrical contact between said conductor and said external circuit.

15. A planar battery comprising:
an anode for supplying electrons;
a porous material comprising a cathode for accepting said electrons;
a current collector for collecting said electrons;
a planar plastic housing for maintaining a predetermined gap between said anode, said porous material and said current collector;
wherein upon a liquid being introduced into said battery, and said liquid being passed to said porous material, said anode and said cathode are able to be activated for supplying electricity; said passing of said liquid being by one of:
surface tension, and capillary action.

16. A planar battery comprising:
an anode for supplying a electrons;
a porous material;
a current collector for collecting said electrons;
a planar plastic housing for maintaining a predetermined gap between said anode, said porous material and said current collector;
wherein upon a liquid with a cathode material being introduced into said battery and said liquid being passed to said porous material, said anode and said cathode are able to be activated for supplying electricity; said passing of said liquid being by one of: surface tension, and capillary action.

17. A battery comprising:
an anode for supplying electrons;
a current collector for collecting said electrons;
a medium between said anode and current collector;
a housing for maintaining a predetermined gap between said anode, said medium and said current collector;
wherein upon a liquid being introduced into said battery and being passed to said medium, and said liquid contacting said anode and a cathode, said anode and said cathode are able to be activated for supplying electricity; said passing of said liquid being by one of: surface tension, and capillary action.

18. The battery of claim 17, wherein said liquid is a liquid based on water.

19. The battery of claim 18, wherein said liquid based on water comprises at least one selected from the group consisting of: blood, sweat, saliva, snivel, urine, vaginal discharge, feces, biofluid, animal DNA, animal RNA, animal protein, animal cells, cell debris of an animal, sap, plant DNA, plant RNA, plant protein, plant cells and cell debris of a plant.

20. The battery of claim 17, wherein said medium comprises of at least one selected from the group consisting of: an empty cavity, a porous material, an hydrophilic material, a cavity lined with an hydrophilic material, microchannels, and a cavity between said anode and said current collector.

21. The battery of claim 20, wherein at least a portion of at least one of: said medium, said porous material or said cavity, comprises said cathode, said cathode being for accepting said electrons.

22. The battery of claim 17, wherein said cathode comprises a chloride material

23. The battery of claim 22, wherein said chloride material is one of: copper chloride, and silver chloride.

24. The battery of claim 17, wherein said anode is of a magnesium material.

25. The battery of claim 17, further comprising a sandwich comprising said anode, said medium and said current collector; said sandwich having at least one channel for introduction of said liquid to said medium.

26. The battery of claim 25, wherein said at least one channel is also for removal of gas from said sandwich.

27. The battery of claim 17, wherein said liquid includes a cathode material for accepting electrons.

28. A planar battery fabrication method comprising:
(a) making a sandwich including following in any combination;
placing a dry porous material on a current collector, the dry porous material including a cathode material and being for providing a capillary force to an introduced liquid;
placing an anode on said porous material: and
(b) laminating a housing around said sandwich for maintaining a predetermined gap between said anode, said porous material and said current collector.

29. A battery fabrication method comprising:
(a) making a structure including following in any combination;
placing a collector;
placing a dry porous material, the dry porous material being for providing a capillary force to an introduced liquid with a cathode;
placing an anode: and
(b) making a housing around said structure for maintaining a predetermined gap between said anode, said porous material and said current collector.
